(19) United States
(12) Patent Application Publication
(10) Pub. No.: US 2020/0036462 A1
(43) Pub. Date: Jan. 30, 2020

(54) Prediction Method And Device

(71) Applicant: Telefonaktiebolaget LM Ericsson (publ), Stockholm (SE)

(72) Inventors: Volodya Grancharov, Solna (SE); Erlendur Karlsson, Uppsala (SE); Valentin Kulyk, Täby (SE)

(21) Appl. No.: 16/330,614

(22) PCT Filed: Sep. 9, 2016
(86) PCT No.: PCT/EP2016/071374

§ 371 Date: Mar. 5, 2019

(51) Int. Cl. H04H 60/31; H04H 60/46; H04H 60/63; H04H 60/66; H04N 21/25; H04N 21/442; H04N 21/658; H04N 21/2547

(52) U.S. Cl. CPC H04H 60/31; H04H 60/46; H04H 60/63; H04N 21/2547; H04N 21/251; H04N 21/44222; H04N 21/6582; H04H 60/66

(57) ABSTRACT

A method in a device for predicting the number of views of broadcast media on a broadcast channel at a future instance in time n+k. The method comprises receiving past values representing the actual number of views of the broadcast media at particular instances in time, and defining a time window previous to the current time n. The past values received during the time window are analysed to determine if the time window is corrupt. The time window is utilised to predict the number of views of the broadcast channel at the future instance in time, n+k, depending on whether the time window is corrupt.

### TECHNICAL FIELD

The present invention relates to a prediction method and device, and in particular to a method and device for predicting the number of views of broadcast media on a broadcast channel at a future instance in time.

### BACKGROUND

Advertisements during TV or radio broadcasts are usually billed by a TV broadcaster in advance for a particular number of views. If the actual number of views is less than what was expected when the billing was made, the broadcaster will have to repeat the advertisement at a later time, or refund the money which was over paid. Conversely, if the actual number of views is more than what was billed for at the time, the broadcasting air time has not been efficiently used.

### SUMMARY

One important research question for broadcast services is the user behavior, and one aspect of this is the knowledge about the number of viewers watching a specific TV channel (e.g. views per hour). This knowledge can be used, for example, to optimize advertisement insertions made by TV broadcasters, or to control bandwidth or other network parameters.

In that respect knowledge about the future number of views at particular points in time can help to plan and distribute the insertions of the advertisements to maximize profit. The embodiments described herein present a method and apparatus to predict the number of views of broadcast media at a future instance in time, for example future viewing hours.

According to a first aspect there is provided a method in a device for predicting at a current time n the number of views of broadcast media on a broadcast channel at a future instance in time n+k. The method comprises receiving past values representing the actual number of views of the broadcast media at particular instances in time, and defining a time window previous to the current time n. The method comprises analysing the past values received during the time window to determine if the time window is corrupt, and utilising the time window to predict the number of views of the broadcast channel at the future instance in time, n+k, depending on whether the time window is corrupt.

According to another aspect there is provided a device for predicting at a current time n the number of views of broadcast media on a broadcast channel at a future instance in time n+k. The device comprises a processor and a memory, the memory containing instructions executable by the processor. The processor is operable to receive past values representing the actual number of views of the broadcast media at particular instances in time, and define a time window previous to the current time n. The processor is operable to analyse the past values received during the time window to determine if the time window is corrupt, and utilise the time window to predict the number of views of the broadcast channel at the future instance in time, n+k, depending on whether the time window is corrupt.

### BRIEF DESCRIPTION OF THE DRAWINGS

FIG. 1 illustrates a graph 100 of the prediction of a point k units of time ahead of a current time n, based on analysis of a time window of size L previous to the current time n;

FIG. 2 illustrates a method according to an embodiment, for predicting the number of views of broadcast media on a broadcast channel at a future instance in time n+k;

FIG. 3 illustrates in more detail an example of the process of step 204 of FIG. 2;

FIGS. 4a to c illustrate graphs of the prediction of a point k units in time ahead of a current time n, according to various embodiments;

FIG. 5 illustrates in more detail an example of the process of step 203 of FIG. 2;

FIG. 6 illustrates a graph of the correlation coefficient of various broadcast channels; and

FIG. 7 illustrates a device 700 according to an embodiment for predicting the number of views of broadcast media on a broadcast channel at a future instance in time n+k.

### DESCRIPTION

As described previously the present embodiments relate to a method and apparatus for predicting at a current time n the number of views of broadcast media on a broadcast channel at a future instance in time n+k. In some embodiments described herein, the number of views of broadcast media are referred to as viewers of TV channels. It is noted, however, that the number of views may be other forms of access to broadcast media, such as listeners to audio broadcast. In some examples described herein, the embodiments relate to predicted future instances in time as being predicting hourly views per TV channel. It is noted, however, that the embodiments are intended to cover other instances or periods in time, including views over different periods of time.

It is also noted that references herein to broadcast media is intended to cover both live broadcast of media, and the streaming or downloading of media content at a later point in time.

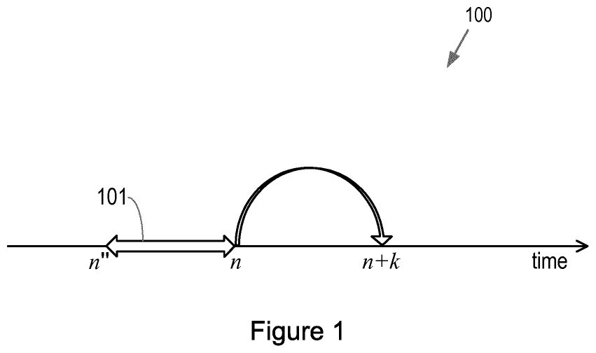

FIG. 1 illustrates a graph 100 of a prediction of a point k units of time ahead of a time n, i.e. a prediction for point n+k in time, based on analysis of a time window of size L previous to the time n.

In FIG. 1 a time window L is shown using reference 101. The time window spans the period between n″ and n, where n is the current time. The values received in this time window are then used to predict the number of views at a future time n+k.

This prediction can be done using an autoregressive (AR) prediction model, which may also be referred to as a linear predictive (LP) model. This type of model is an efficient technique for predicting future values of a time series based on a linear combination of past values, for example a weighted linear combination of past values. One example of such an AR prediction model is described below.

For the time series {x(m): m=1,2,3, . . . }, the AR model at time n for predicting x(n+k) from the current and past values x(n), x(n−1), . . . x(n−P) where P+1 is the number of AR prediction coefficients, is given by

$${\hat{x}}_{n} ( n + k ) = {\sum }_{p = 0}^{P} {a}_{n , p} x ( n - p ) \qquad ( 1 )$$

where the coefficients a_{n,0}, a_{n,1}, . . . a_{n,p} are the prediction coefficients, and k is the prediction step (k≥1). The optimal prediction coefficients at time n, â_{n,0}, â_{n,1}, . . . â_{n,p} are evaluated as the coefficients that minimize the least squares prediction over the times n, n−1, . . . n−L for some L>>P. The optimal prediction coefficients may therefore be given as:

$${\hat{a}}_{n} = ( \begin{matrix}{\hat{a}}_{n , 0} \\ ⋮ \\ {\hat{a}}_{n , P}\end{matrix} ) = {arg min}_{{a}_{n}} {\sum }_{m = n - L}^{n} {( x ( m ) - {\sum }_{p = 0}^{P} {a}_{n , p} x ( m - k - p ) )}^{2} \qquad ( 2 )$$

To help clarify the relationship between the length of the analysis window, the length of the basis vectors used in the AR prediction and the AR model order P, the AR prediction equation is displayed in the following matrix format (2a): This helps to find the AR parameter vector aₙ that minimizes the norm of the prediction error:

$$( \begin{matrix}e ( n - L ) \\ ⋮ \\ e ( n )\end{matrix} ) = ( \begin{matrix}x ( - L ) \\ ⋮ \\ x ( n )\end{matrix} ) - \underbrace{( \begin{matrix}x ( n - k - L ) & … & x ( n - k - P - L \\ ⋮ & ⋱ & ⋮ \\ x ( n - k ) & … & x ( n - k - P )\end{matrix} )}_{{X}_{n - k , L , P}} \underbrace{( \begin{matrix}{a}_{n , 0} \\ ⋮ \\ {a}_{n , P}\end{matrix} )}_{{a}_{n}} \qquad ( 2 a )$$

As can be seen above the length of the basis vectors used in the AR prediction is L+1, the number of AR prediction coefficients is P+1 and the data analysis window is (n″:n)=(n−k−P−L:n), which makes the length of the data analysis window equal to k+P+L+1.

The solution to equation (2) can be found using a standard least squares estimation problem. The solution can be given by:

âₙ=A⁻¹X (3)

where the data matrix A is representative of the data window and can be expressed as:

$$\begin{matrix}A = ( \begin{matrix}〈 {x}_{n - k} , {x}_{n - k} 〉 & … & 〈 {x}_{n - k} , {x}_{n - k - P} 〉 \\ ⋮ & ⋱ & ⋮ \\ 〈 {x}_{n - k - P} , {x}_{n - k} 〉 & … & 〈 {x}_{n - k - P} , {x}_{n - k - P} 〉\end{matrix} ) & ( 4 ) \\ and , & \\ X = ( \begin{matrix}〈 {x}_{n - k} , {x}_{n} 〉 \\ ⋮ \\ 〈 {x}_{n - k - P} , {x}_{n} 〉\end{matrix} ) & ( 5 )\end{matrix}$$

where <xₙ,xₘ> is the inner product between the vectors xₙ and xₘ, wherein the vector xₙ is given by:

$${x}_{n} = ( \begin{matrix}x ( n - L ) \\ ⋮ \\ x ( n )\end{matrix} ) . \qquad ( 6 )$$

The matrix inversion shown in equation (3) can be achieved, for example, through Singular Value Decomposition (SVD). In this technique the data matrix A can be rewritten as:

A=USV^{T}. (7)

In Equation (7) U and V are unitary matrices and S is a diagonal matrix with non-negative real numbers on the diagonal. Therefore the matrix S can be written as:

S=diag(s₁, s₂, . . . , s_{L},) (8)

Since the inversion of a diagonal matrix such as S is trivial, the inversion of A of equation (3) can be expressed as:

A⁻¹=VS⁻¹U^{T} (9)

Equations (9) and (3) can then be used to determine the coefficients to be used in Equation (1) to predict the future value x(n+k).

Theoretically, the larger the time window the more accurate the prediction, and therefore the optimal solution would be to use all past data in the AR model. However, this assumes that the data statistics do not evolve with time. This is not the case for real data recordings. The time window could therefore be shortened to follow the signal dynamics, but in this case the model parameters can be easily affected by outliers or corrupted data. Solutions to this problem of the present embodiments are discussed with reference to the remaining Figures.

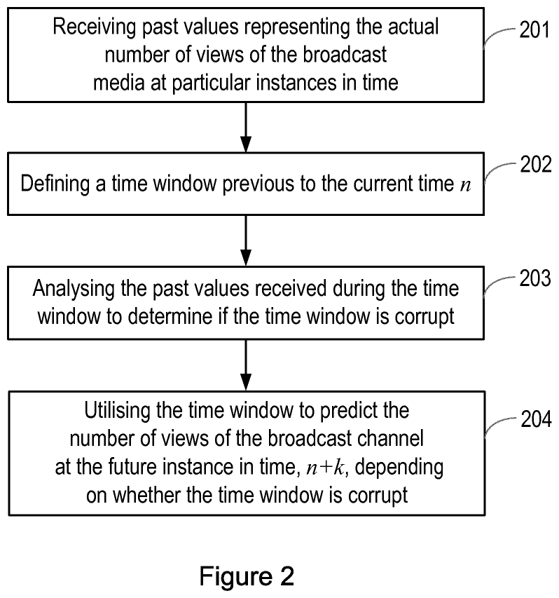

FIG. 2 illustrates a method in a device for predicting at a current time n the number of views of broadcast media on a broadcast channel at a future instance in time n+k according to embodiments of the invention.

As mentioned above, it will be appreciated that a broadcast channel may comprise a TV channel or audio broadcast channel and that the broadcast may be live, on-demand, or any other streaming service.

In step 201 the method comprises receiving past values representing the actual number of views of the broadcast media at particular instances in time. For example, this step may comprise receiving continual historical data relating to the actual number of views of broadcast media at particular instances in time (for example hourly viewer figures over a period of time in the past).

In step 202 the method comprises defining a time window previous to the current time n.

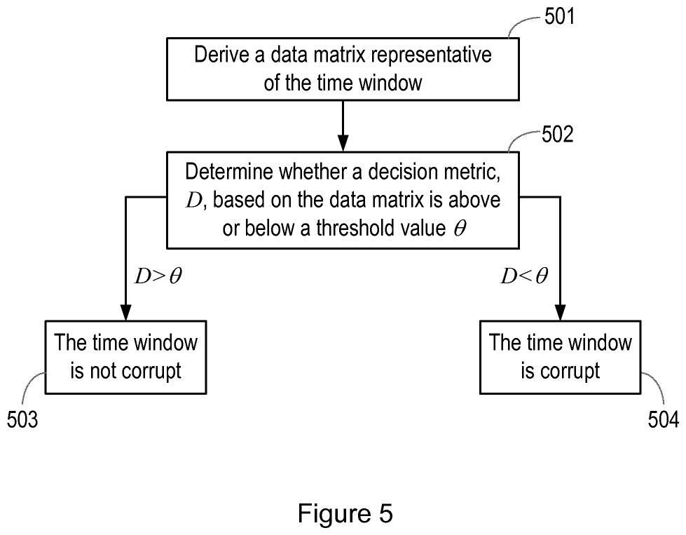

In step 203 the method comprises analysing the past values received during the time window to determine if the time window is corrupt. An example of this analysis is discussed in more detail with reference to FIG. 5.

In step 204 the method comprises utilising the time window to predict the number of views of the broadcast channel at the future instance in time, n+k, depending on whether the time window is corrupt.

Thus, a defined time window is selected for a prediction, but a check is performed to determine whether or not the defined time window is to be then utilised for the prediction, depending upon whether or not the time window is corrupt.

In the embodiments described herein, the time window is defined between a first time n″ (corresponding to the beginning of the time window) and a second time n′ (corresponding to the end of the time window).

For example the second time n′ can be the same as the current time n. In such an embodiment the time window therefore spans a period immediately prior to the current time n.

In other embodiments, the second time n′ is prior to the current time n. In such an embodiment the time window therefore spans a period prior to the current time n. The difference between the current time n and the second time n′ may relate, for example, to a processing delay between the end of the time window and the current time n when the prediction is performed. Alternatively, the difference between the current time n and the second time n′ may relate, for example, to a time shift required in order to match the position of the time window which is to be used as the basis for analysis with the future time instance n+k that is being predicted (for example in a scenario where k is not equal to 24 hours).

In some embodiments, the past values are extracted from received data in a pre-processing stage. The past values can be extracted and filtered from the received data. This method and pre-processing may be performed by a single processor. In other embodiments, the method and the pre-processing may be performed in different modules or devices.

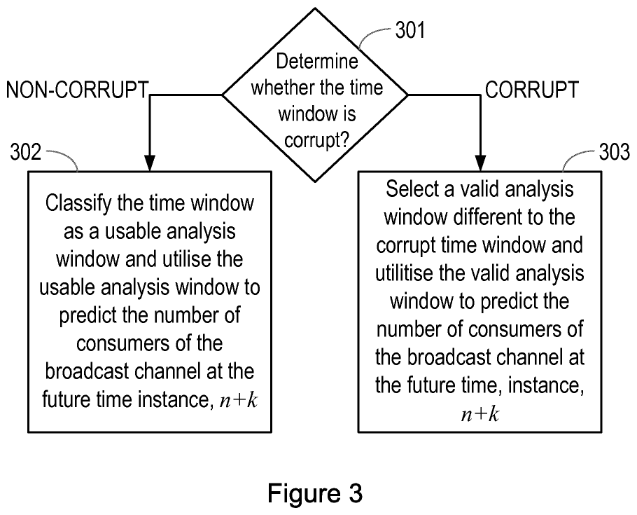

FIG. 3 illustrates in more detail an example of the process of step 204 of FIG. 2.

In step 301 the device determines whether or not the time window is corrupt. In some embodiments the time window is corrupt if it contains any erroneous data.

Erroneous data may refer to outliers or anomalies in the data. For example, for a TV broadcasting channel, the number of views may exhibit unpredictable behaviour if a particular channel is broadcasting media of unusually high interest, for example a particularly shocking news broadcast. This will have the effect of reducing the number of views on other broadcast channels and increasing the number of views on the channel broadcasting the news. This is seen as erroneous as it is not a typical consumer response to the media usually being broadcasted at that particular time.

Other examples of erroneous data can be envisaged, for example hardware failures, which can lead to the number of views being unrealistically constant over a period of time. In such scenarios data or part of the data can be lost or incomplete due to bad network conditions or software failure. In these scenarios different modules can be responsible for data reporting, collection, processing and storage. The incomplete data might reflect a typical consumer response to the media in time, but not in terms of the exact number of times the media is viewed. It is noted that the detection of erroneous data in a time window may include other techniques, including ones which are specific or related in some way to the type of broadcast media or TV channel.

If it is determined in step 301 that the time window is not corrupt, the method passes to step 302 wherein the device classifies the time window as a usable analysis window and utilises the usable analysis window to predict the number of views of the broadcast channel at the future instance in time, n+k.

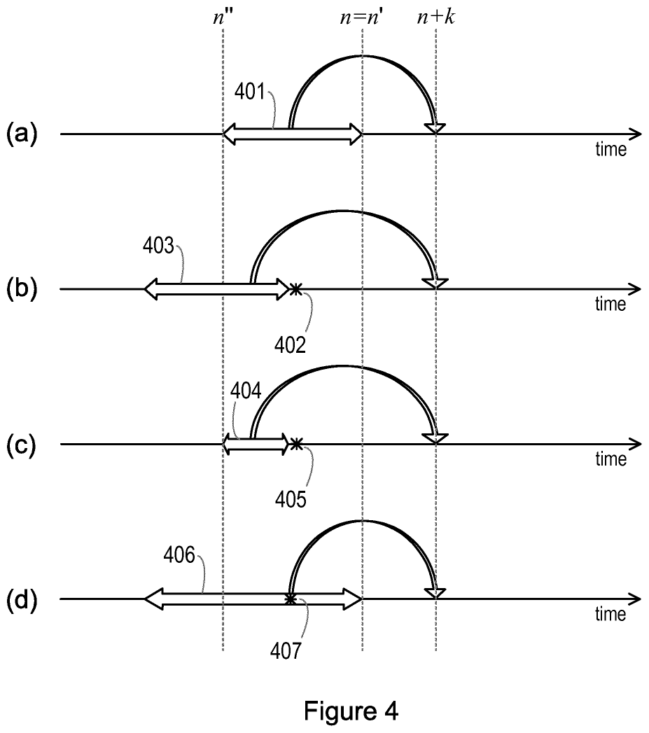

This is described in more detail with reference to FIG. 4a. FIG. 4a illustrates a graph of the prediction of a point k units in time ahead of a current time n, i.e. at n+k. In this example of FIG. 4a (and FIGS. 4b to 4d described below), the time window being analysed to determine whether or not it comprises corrupt data exists immediately before the current time n, i.e. the second time n′ (i.e. the end of the time window) is equal to the current time n. It will be appreciated that the time window being analysed for corrupt data could be a shifted time window in the past, prior to the current time n, such that the second time n′ is not equal to the current time n.

In FIG. 4a the time window 401 has been found to be non-corrupt, and therefore this is the time window which is utilised as a usable analysis window to predict the number of views at the future instance in time n+k.

Returning to FIG. 3, if it is determined in step 301 that the time window is corrupt the method passes to step 303, wherein the method comprises selecting a valid analysis window different to the corrupt time window and utilising the valid analysis window to predict the number of views of the broadcast channel at the future instance in time, n+k. This is described in more detail with reference to FIGS. 4b to 4c. FIGS. 4b to 4c illustrate graphs of the prediction of a point k units in time ahead of a current time n, i.e. at n+k.

In some embodiments, for example the embodiment shown in FIG. 4b, the step 303 of selecting a valid analysis window comprises selecting a usable analysis window, wherein the usable analysis window is a non-corrupt time window from a previous iteration of the method.

As can be seen in FIG. 4b, the time window 401 has been found to be corrupt, as can be seen from the corruption point 402, and therefore, in this example, a valid analysis window is selected from a previous usable time window 403, which is then utilised to predict the future instance in time n+k. In this embodiment, the size of the usable time window 403 is the same as the size of the corrupt time window 401. In some embodiments the usable time window 403 is simply a time window from a previous iteration of the method which was found to be non-corrupt.

For example, in some embodiments, the usable analysis window is the most recent usable analysis window, i.e. the last time window from the most recent iteration of the method which found the time window to be non-corrupt. Therefore, in this embodiment the usable analysis window may be the time window immediately before the corruption point 402.

In some embodiments, for example the embodiment shown in FIGS. 4c and 4d the step 303 of selecting a valid analysis window comprises altering the size of the time window.

In FIG. 4c the step 303 of altering the size of the time window comprises reducing the size of the time window so as to avoid any erroneous data in the corrupt time window, i.e. the time window as originally defined. Therefore the size of the time window 404 is reduced, for example, to just before the corruption point 405.

In FIG. 4d, the step 303 of altering the size of the time window comprises enlarging the size of the time window 406 so that any erroneous data, for example the corruption point 407, has less of an impact on the quality of the data in the time window. In this respect the time window is enlarged compared to the originally defined time window, whereby the original time window can be considered as a nominal time window.

FIG. 5 illustrates in more detail an embodiment of the process of step 203 of FIG. 2, relating to how past values are analysed during the defined time window to determine if the time window is corrupt.

In step 501 the method in the device comprises deriving a data matrix representative of the time window.

For example the matrix A as described above in equation (4).

In step 502, the method comprises determining whether a decision metric, for example D, based on the data matrix is above or below a threshold value, for example θ.

If the decision metric D is above the threshold value θ, the method passes to step 503 wherein it is determined that the time window is not corrupt.

If the decision metric D is below the threshold value θ, the method passes to step 504 wherein it is determined that the time window is corrupt.

For example, when using the autoregressive model as described previously the decision metric, D, may be as follows:

$$\begin{matrix}if D > Θ \\ {\hat{a}}_{n} = {A}^{- 1} X \\ {A}_{*} = A \\ else \\ {\hat{a}}_{n} = {A}_{*}^{- 1} X\end{matrix} , \qquad ( 10 )$$

where A* is the usable time window, or the valid time window as described in FIGS. 4a to 4d, and Θ is a threshold value.

The decision metric D, may be based, for example, on readily available eigenvalues of the diagonal matrix S, for example:

$$D = log ( det ( S ) ) = log ( {\prod }_{i = 1}^{L} {s}_{i} ) \qquad ( 11 )$$

The decision metric, D, is related to the hypervolume defined by the columns of the diagonal matrix, S. This metric, D, is motivated by the fact that when determinant of a matrix approaches zero (hypervolume degenerates and flattens) an indication is made that columns of the matrix are linearly dependent. In other words, D in equation (11) becomes negative when the prediction matrix A begins to approach a state of linear dependence between the basis vectors of the matrix.

The decision metric, D, in equation (11) is only one of many possible decision metrics that can be used. One can also envision other decision metrics involving the singular values of the A matrix such as the ratio between the highest and lowest singular values or a measure characterizing the distribution of the singular values.

The threshold Θ in equation (10) could be set, for example, to a fixed value or adapted to the level of past D values.

The above described embodiments predict at a current time n the number of views of the broadcast channel at a future instance in time, n+k, using an autoregressive prediction model as previously described. It will however be appreciated, the various analysis windows used to predict the number of views of the broadcast channel at the future instance in time n+k, may be used in any other suitable prediction model.

Where an autoregressive model is used the time window may have a size L+k+P+1, where L+1 is the length of basis vectors used in the autoregressive prediction model, P+1 is the number of coefficients used in the autoregressive prediction model, and k is the time between the current time n and the future instance in time n+k.

In some embodiments the value of L is significantly greater than the value of P and typically increases with increased value of k. In some examples the value of L is at least twice the value of k.

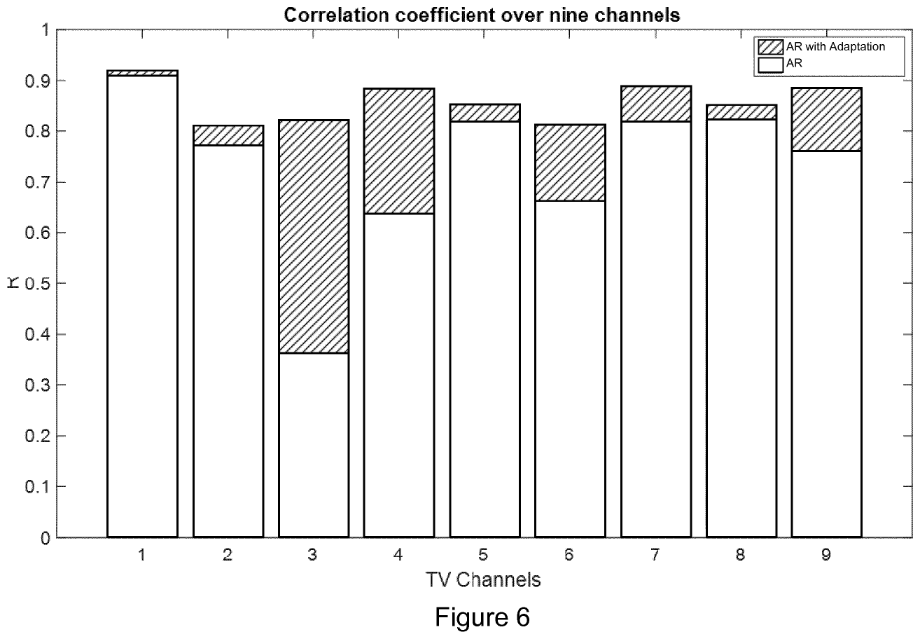

In an example embodiment for a prediction of k=24 hours (i.e. 24 hours ahead), a fixed threshold for the decision metric D was used, Θ=120. This may be optimal for a model with P=30 and L=240 i.e. with a time window of length L+P+k+1=240+30+24+1=295 hours. The inventors have found that for k=24 hours ahead in time, by analysing the time window to check that it is not corrupt the average correlation coefficient improves from 0.73 to 0.86. This can be seen in the graph of FIG. 6. It will be appreciated that any value of k may be used. However, it is noted that, especially for TV broadcasting purposes, the prediction of the number of views a day, or an integer number of days, ahead of the time n, may be a useful prediction.

The predication of the number of views at the future instance in time can be used, for example, to determine the advertisement to be placed at that future instance in time. This will therefore help to alleviate the problem of the actual number of views being less or more than what was expected when the billing for the advertisement was made, as the advertisement can be placed at a time when the prediction shows that the number of views is at least close to the number billed for.

It will also be appreciated that the prediction of the number of views at the future instance in time may also be used for other applications, for example to predict traffic flow for bandwidth purposes or controlling other network parameters, or other service enhancing functions.

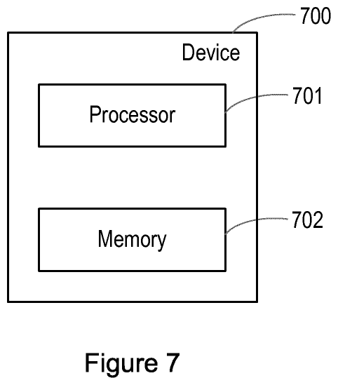

FIG. 7 illustrates a device 700 for predicting at a current time n the number of views of broadcast media on a broadcast channel at a future instance in time n+k according to another embodiment.

The device 700 comprises a processor 701 and memory 702, the memory 1103 containing instructions executable by the processor 701. The processor is operable to: receive past values representing the actual number of views of the broadcast media at particular instances in time; define a time window previous to the current time n; analyse the past values received during the time window to determine if the time window is corrupt; and utilise the time window to predict the number of views of the broadcast channel at the future instance in time, n+k, depending on whether the time window is corrupt. The processor 701 may be adapted to perform other method steps descripted herein.

It is noted that the device 700 may be a stand-alone device, or form part of another device in a communications network, including for example part of a cloud based node.

As will be seen from the above, the embodiments described herein can be used to predict future hourly views, for example using an AR model, and since the signal statistics evolve with time, an analysis window for building the AR model can also be shifted with time, by defining a time window previous to a current time n. This time window is checked before applying to the prediction model. If the data is decided to be erroneous, another time window is selected (for example a data-optimized, but fixed in size analysis window), for example a model derived from the last good analysis window, or alternatively a reduced or enlarged time window to avoid the effect of the erroneous data.

The embodiments described herein therefor enable the number of views of broadcast media on a broadcast channel at a future instance in time to be predicted more accurately.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-19. (canceled)

20. A method, in a device, for predicting at a current time n a number of views of broadcast media on a broadcast channel at a future instance in time n+k, the method comprising:
receiving past values representing an actual number of views of the broadcast media at particular instances in time;
defining a time window previous to the current time n;
analyzing the past values received during the time window to determine if the time window is corrupt; and
predicting, utilizing the time window, the number of views of the broadcast channel at the future instance in time (n+k) based on whether the time window is corrupt.

21. The method of claim 20, wherein the method further comprises, if the time window is not corrupt:
classifying the time window as a usable analysis window; and
utilizing the usable analysis window to predict the number of views of the broadcast channel at the future instance in time n+k.

22. The method of claim 20, wherein the method further comprises, if the time window is corrupt:
selecting a valid analysis window different to the corrupt time window; and
utilizing the valid analysis window to predict the number of views of the broadcast channel at the future instance in time n+k.

23. The method of claim 22:
wherein the selecting a valid analysis window comprises selecting a usable analysis window; and
wherein the usable analysis window is a non-corrupt time window from a previous iteration of the method.

24. The method of claim 23, wherein the usable analysis window is the most recent usable analysis window.

25. The method of claim 22, wherein the selecting the valid analysis window comprises altering a size of the time window.

26. The method of claim 25, wherein the altering the size of the time window comprises reducing the size of the time window so as to avoid any erroneous data in the corrupt time window.

27. The method of claim 25, wherein the altering the size of the time window comprises enlarging the size of the time window so that any erroneous data has less of an impact on the quality of the data in the time window.

28. The method of claim 20, wherein the analyzing the past values to determine if the time window is corrupt comprises:
deriving a data matrix representative of the time window;
determining whether a decision metric based on the data matrix is above or below a threshold value;
wherein, if the decision metric is above the threshold value, the time window is determined to be not corrupt;
wherein, if the decision metric is below the threshold value, the time window is determined to be corrupt.

29. The method of claim 20, wherein the time window is defined between a first time n″ and a second time n′.

30. The method of claim 29, wherein the second time n′ is the same as the current time n.

31. The method of claim 29, wherein the second time n′ is prior to the current time n.

32. The method of claim 20, wherein the predicting the number of views of the broadcast channel at a future instance in time n+k comprises using an autoregressive prediction model.

33. The method of claim 32:
wherein the time window has a size L+k+P+1,
where L+1 is a length of basis vectors used in the autoregressive prediction model, P+1 is a number of coefficients used in the autoregressive prediction model, and k is a time between the current time n and the future instance in time n+k.

34. The method of claim 33, wherein L is significantly greater than the value of P and typically increases with increased value of k, or wherein L is at least twice the value of k.

35. The method of claim 20, wherein the time window is corrupt if the time window contains any erroneous data.

36. The method of claim 35, wherein erroneous data comprises data representative of outliers or anomalies.

37. A device for predicting, at a current time n, a number of views of broadcast media on a broadcast channel at a future instance in time n+k, the device comprising:
processing circuitry;
memory containing instructions executable by the processing circuitry whereby the device is operative to:
receive past values representing an actual number of views of the broadcast media at particular instances in time;
define a time window previous to the current time n;
analyze the past values received during the time window to determine if the time window is corrupt; and
predict, utilizing the time window, the number of views of the broadcast channel at the future instance in time n+k based on whether the time window is corrupt.

38. The device of claim 37, wherein the instructions are such that the device is operative to, if the time window is corrupt:
select a valid analysis window different to the corrupt time window; and
utilize the valid analysis window to predict the number of views of the broadcast channel at the future instance in time n+k.

39. The device of claim 38, wherein the instructions are such that the device is operative to select the valid analysis window by altering a size of the time window.
